(19) United States
(12) Patent Application Publication
(10) Pub. No.: US 2007/0137043 A1
(43) Pub. Date: Jun. 21, 2007

(54) Electric shaving apparatus with oscillatory shaving head

(76) Inventors: Bernhard Kraus, Braunfels (DE); Stefan Rehbein, Frankfurt a. M. (DE); Uwe Schober, Glashutten-Schlossborn (DE)

Correspondence Address: FISH & RICHARDSON PC, P.O. BOX 1022, MINNEAPOLIS, MN, 55440-1022, US

(21) Appl. No.: 11/640,076

(22) Filed: Dec. 15, 2006

(30) Foreign Application Priority Data
Dec. 17, 2005 (DE) 10 2005 060 537.0

(51) Int. Cl. B26B 19/12

(52) U.S. Cl. 30/43.9

(57) ABSTRACT

An electric shaving apparatus has a hand-holdable housing and a shaving head. The shaving head is coupled to the housing via at least one first elastic element and has at least one first shaving cutter. The shaving apparatus includes an electric motor for generating an oscillatory motion of the shaving head and an oscillatory motion differing therefrom of at least one second shaving cutter. The electric motor has a first drive component with at least one electric coil for generating a magnetic field, and a second drive component. The first drive component of the electric motor is rigidly connected to the shaving head or to the housing.

### CROSS REFERENCE TO RELATED APPLICATIONS

This application claims priority under 35 U.S.C. § 119(a) from German application serial number DE 10 2005 060 537.0, filed Dec. 17, 2005, the entire contents of which are hereby incorporated by reference.

### TECHNICAL FIELD

This invention relates to an electric shaving apparatus having a shaving head that executes an oscillatory motion relative to a hand-holdable housing.

### BACKGROUND

A shaving apparatus having an oscillating head is disclosed in DE 103 30 978 A1. This document discloses an electric shaving apparatus with a statorless linear motor having two rotors. The shaving apparatus has a housing on which are movably suspended a first shaving head part and a second shaving head part by means of leaf springs. Through further leaf springs each shaving head part is connected to a respective rotor so that the shaving head parts are driven via these further leaf springs by the rotors. In addition, the rotors drive shaving cutters that are rigidly connected to the rotors and that cooperate with the shaving head parts in order to sever the hairs. In particular, the shaving head parts and the associated shaving cutters are set in oscillations in phase opposition to each other. In this manner, low-vibration operation accompanied by high efficiency can be accomplished. However, the leads to a coil arranged on one of the rotors have to be designed such that they do not suffer any damage due to the oscillatory motion of the rotor.

### SUMMARY

One aspect of the invention features an electric shaving apparatus with a hand-holdable housing and a shaving head. The shaving head is coupled to the housing via at least one first elastic element and has at least one first shaving cutter. The shaving apparatus also includes an electric motor for generating an oscillatory motion of the shaving head and an oscillatory motion of at least one second shaving cutter differing from the oscillatory motion of the shaving head. The electric motor has a first drive component with at least one electric coil for generating a magnetic field, and a second drive component that cooperates with the first drive component to generate a motive force, such as a linear force or torque. The shaving apparatus is characterized in that the first drive component of the electric motor is rigidly connected to either the shaving head or the housing.

The shaving apparatus described in more detail below can provide the advantage of enabling low-vibration operation accompanied by high efficiency. Another advantage can include that the shaving apparatus is of comparatively straightforward design and can be configured to require no gearing. Still another advantage is that several drive motions can be generated using a single electric motor. Owing to the rigid coupling to either the shaving head or the housing of the shaving apparatus, the first drive component executes at most an oscillatory motion with a relatively small amplitude. This can provide the advantage that the leads to the coil of the first drive component do not need to be exposed to particular loads, and therefore require no particularly elaborate construction.

The electric motor is preferably constructed as a linear motor. The second drive component is arranged preferably in the shaving head. This affords advantages with regard to the avoidance of unwelcome vibrations.

In a preferred embodiment of the shaving apparatus the second drive component includes at least one permanent magnet, hence eliminating the need for leads to the second drive component.

The oscillatory motions of the shaving head and of the second shaving cutter are preferably in phase opposition to each other. This enables a high cutting speed to be accomplished, so that a very thorough shave is possible. Moreover, it is advantageous for the oscillatory motion of the shaving head to have a smaller amplitude than the oscillatory motion of the second shaving cutter. To keep undesired vibrations at a particularly low level, the shaving apparatus can be designed in such a way that during the oscillatory motion of the shaving head and during the oscillatory motion of the second shaving cutter the mass center of the shaving head, inclusive of the components rigidly connected to the shaving head, and the mass center of the second shaving cutter, inclusive of the components rigidly connected to the second shaving cutter, move on a common line.

The first drive component and the second drive component may be coupled via at least one second elastic element. Preferably, the second elastic element has a greater spring constant than the first elastic element so that the mutual coupling of the two drive components is stronger than the coupling between the shaving head and the housing. In consequence, the amount of unwelcome vibrations to which the housing is possibly excited is at most very small.

In a further aspect of the shaving apparatus, the second drive component is coupled to a compensating element via at least one third elastic element. As a result, additional options are available with regard to the distribution of masses to obtain a low-vibration operation of the shaving apparatus. The third elastic element preferably has a greater spring constant than the second elastic element. In some cases the compensating element is rigidly connected to the second shaving cutter. Alternatively, the possibility also exists for the second drive component to be rigidly connected to the second shaving cutter. In another design variant, the second drive component is coupled to the second shaving cutter via at least one fourth elastic element. In this arrangement the second shaving cutter can additionally be coupled to the shaving head through at least one fifth elastic element. By means of this coupling the shaving head can be set in an oscillatory motion.

In a preferred embodiment of the shaving apparatus the first shaving cutter is constructed as a shaving foil. The second shaving cutter is preferably constructed as an undercutter cooperating with the first shaving cutter.

The first elastic element and/or the second elastic element and/or the third elastic element and/or the fifth elastic element is preferably constructed as a leaf spring. Leaf springs have the advantage of being very stiff in a direction transverse to the intended direction of movement.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic representation of a first electric shaving apparatus.

FIG. 2 is a block diagram of the oscillatory system for the shaving apparatus illustrated in FIG. 1.

FIG. 3 is a graph showing the oscillatory behavior of the oscillatory system illustrated in FIG. 2.

FIG. 4 is a representation corresponding to FIG. 1 of a second shaving apparatus.

FIG. 5 is a is a block diagram of the oscillatory system for the shaving apparatus illustrated in FIG. 4.

FIG. 6 is a graph showing the oscillatory behavior of the oscillatory system illustrated in FIG. 5.

FIG. 7 is a representation of a third shaving apparatus.

FIG. 8 is a is a block diagram of the oscillatory system for the shaving apparatus illustrated in FIG. 7.

FIG. 9 is a graph showing the oscillatory behavior of the oscillatory system illustrated in FIG. 8.

FIG. 10 is a representation of a fourth shaving apparatus.

FIG. 11 is a block diagram of the oscillatory system for the shaving apparatus illustrated in FIG. 10.

FIG. 12 is a graph showing the oscillatory behavior of the oscillatory system illustrated in FIG. 11.

Like reference symbols in the various drawings indicate like elements.

### DETAILED DESCRIPTION

FIG. 1 shows schematically a first embodiment of an electric shaving apparatus. The shaving apparatus has a housing 1 shown in FIG. 1 only in part. The housing 1 is shaped such as to enable a user of the shaving apparatus to hold it comfortably in his hand. The shaving apparatus furthermore includes a shaving head 2 with at least one shaving foil 3. The shaving head 2 is secured to the housing 1 by means of leaf springs 4. The characteristic of the leaf springs 4 is that they act like rigid bodies within the plane defined by them while yielding resiliently perpendicularly to that plane. This means that in the representation of FIG. 1 the shaving head 2 can be moved to the left and right relative to the housing 1 by overcoming the restoring force produced by the leaf springs 4. This makes it possible to set the shaving head 2 in an oscillatory motion relative to the housing 1.

Arranged in the area of the shaving head 2 is an electric motor 5 having a stator 6 that is stationary relative to the shaving head 2 and a movable rotor 7. The stator and rotor cooperate to produce a motive force, by operation of a shared magnetic field generated by electric current, as is known in the art of electric motors. As will be explained in greater detail in the following, in the first embodiment the stator 6 is not stationary relative to the housing 1 but executes, with the shaving apparatus in operating state, a linear oscillating motion in conjunction with the shaving head 2. The term “stator” is nevertheless used, because the stator 6 is stationary relative to the shaving head 2 and the oscillatory motion of the stator 6 has a substantially smaller amplitude than the oscillatory motion of the rotor 7.

The stator 6 includes an iron core 8 which is U-shaped in cross-section and is rigidly connected to the shaving head 2 by means of brackets 9. Wound about the iron core 8 are two coils 10. The coils 10 are connected to an electronic circuitry, not shown in the Figure, which is arranged in the interior of the housing 1 and through which the supply of current to the coils 10 is controlled.

The rotor 7 has a supporting plate 11 mounting several permanent magnets 12. Similar to the iron core 8, the supporting plate 11 is made from an iron material. A rod 13 rigidly connects the rotor 7 with an undercutter 14 disposed adjacent to the shaving foil 3. In the event of several shaving foils 3 being provided, a corresponding number of undercutters 14 is also provided. The rotor 7 is secured to the stator 6 by means of leaf springs 15.

With the shaving apparatus in an operating state, current is supplied to the coils 10 of the stator 6 to produce a magnetic field that acts on the permanent magnets 12 of the rotor 7. This causes the rotor 7 to be displaced laterally relative to the stator 6. By means of a periodic control of the coils 10 known in the art, the rotor 7 is displaced in opposite directions in alternation and returned to its position of rest by the restoring forces of the leaf springs 15. In this manner, the rotor 7 executes a linear oscillating motion. This oscillating motion is transferred to the undercutter 14 via the rod 13. Because of the finite mass of the shaving head 2 the stator 6 does not remain exactly stationary but is displaced a slight amount in a direction opposite to the direction of movement of the rotor 7. In consequence, the stator 6 also executes an oscillating motion, but with a substantially smaller amplitude than the oscillating motion of the rotor 7 and in phase opposition thereto. Through the brackets 9 the oscillating motion of the stator 6 is transmitted to the shaving head 2 whose movability is made possible by the leaf springs 4. As a component part of the shaving head 2, the shaving foil 3 also performs an oscillating motion. The oscillating motion of the shaving foil 3 has a smaller amplitude than the oscillating motion of the undercutter 14 and takes place in phase opposition thereto. By virtue of these opposing oscillating motions of the shaving foil 3 and the undercutter 14, hairs penetrating through the shaving foil 3 into the region of the undercutter 14 can be severed reliably.

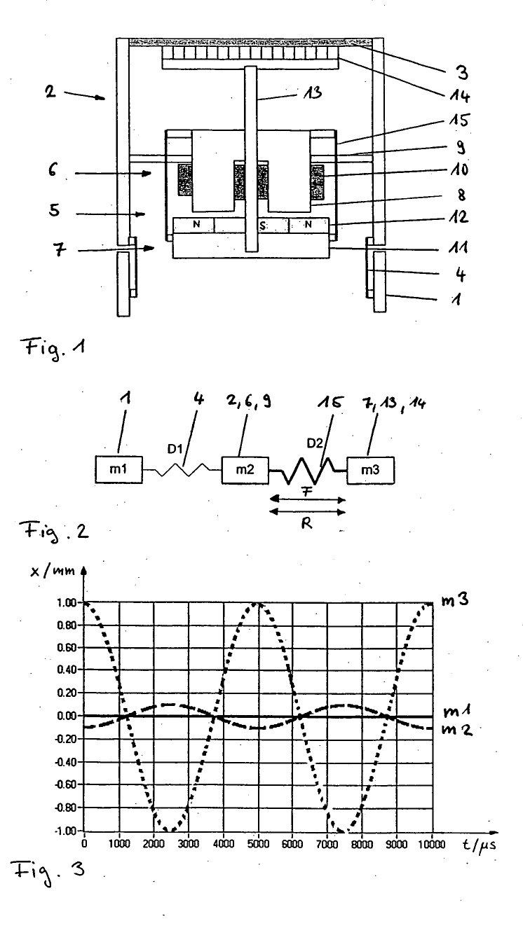

Overall, therefore, the components illustrated in FIG. 1 provide a spring-mass system capable of oscillating, which, given a suitable dimensioning, has a high efficiency and causes only little vibration of the housing 1. The properties of this oscillatory system will be explained in greater detail with reference to FIGS. 2 and 3.

FIG. 2 shows a block diagram of the oscillatory system for the shaving apparatus illustrated in FIG. 1. The individual blocks are representative of the masses of the jointly moving components and are designated by the reference characters assigned to these components. Components connected rigidly to one another move as one. The leaf springs 4 and 15 are illustrated by spring symbols drawn between adjacent blocks. Finally, a magnetic force F acting between the stator 6 and the rotor 7 and a braking force R produced in particular by friction are represented by a respective double arrow.

As becomes apparent from FIG. 2, a spring force of the leaf springs 4 characterized by a spring constant D1 acts between a mass ml formed by the housing 1 and the components disposed therein and a mass m2 formed by the shaving head 2, the brackets 9 and the stator 6. A spring force of the leaf springs 15 characterized by a spring constant D2 acts between the mass m2 and a mass m3 formed by the rotor 7, the rod 13 and the undercutter 14. Furthermore, acting between the masses m2 and m3 are the magnetic force F, which is produced by the interaction between the magnetic field generated by the coils 10 and the permanent magnets, as well as the braking force R.

Good results are obtainable in particular when the masses m1, m2 and m3 are graded such that mass m2 has the largest and m3 the smallest value. The value of mass ml then lies between the masses m2 and m3 and preferably closer to mass m2 than to mass m3. The spring constants D1 and D2 are generally of different magnitudes. Preferably, spring constant D2 is greater than spring constant D1 so that the elastic coupling between the masses m2 and m3 is greater than the elastic coupling between the masses ml and m2. This means that the elastic coupling between the stator 6 and the rotor 7 is greater than the elastic coupling between the shaving head 2 and the housing 1. The oscillatory behavior of the oscillatory system shown in FIG. 2 will be explained in greater detail with reference to FIG. 3.

FIG. 3 is a graph showing the oscillatory behavior of the oscillatory system illustrated in FIG. 2. Time t is plotted on the abscissa, and the respective displacement x of the mass center from its rest position is plotted on the ordinate for the three masses m1, m2 and m3. The curve shape for mass m1 is illustrated as a solid line. For mass m2 the curve shape is shown as a broken line, and for mass m3 as a dotted line. The curves were determined, by way of example, for an oscillation frequency f=200 Hz, a braking force R=1 N, a mass m1=70 g, a mass m2=100 g, a mass m3=10 g, a spring constant D1=2 N/mm, and a spring constant D2=14.4 N/mm. The oscillation amplitudes of the mass centers of the masses m1, m2 and m3 amount to x1=0.002 mm, x2=0.1 mm, and x3=1.0 mm.

Since the oscillation amplitude x1 is very small, the oscillatory motion of the mass center of mass m1 is not recognizable in FIG. 3. In other words, the housing 1 is set in only very small vibrations when the shaving apparatus is in operation. The oscillation of the mass center of mass m2 is clearly visible in FIG. 3, being however substantially less pronounced than the oscillation of the mass center of mass m3, since the relative behavior of the oscillation amplitudes x2 and x3 is reciprocal to that of the masses m2 and m3. This means that the oscillation of the undercutter 14 is substantially greater than that of the shaving foil 3. As becomes further apparent from FIG. 3, the mass centers of the masses m2 and m3 oscillate in phase opposition to each other and have the same oscillation frequency. To achieve a high efficiency, a value is selected for the oscillation frequency f that is preferably in the proximity of the resonant frequency of the subsystem provided by the masses m2 and m3 and the spring constant D2. In addition, the geometry of the components forming the masses m2 and m3 is selected such that the mass centers of the masses m2 and m3 move at least approximately on a common line, so that aside from the resultant linear pulse also the resultant angular momentum is approximately equal to zero and, hence, hardly any undesirable vibrations occur.

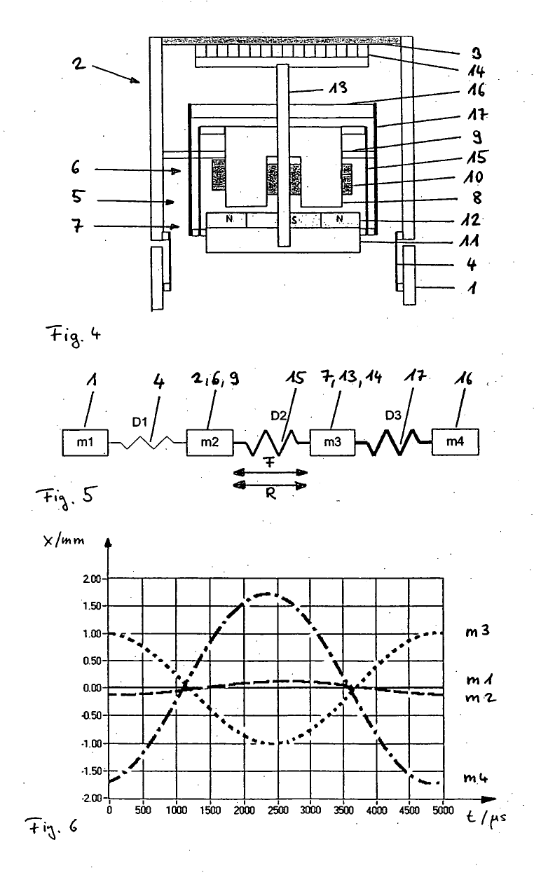

FIG. 4 shows a second shaving apparatus in a representation corresponding to FIG. 1. An associated block diagram of the. oscillatory system is shown in FIG. 5. The oscillatory behavior of the oscillatory system is shown in FIG. 6.

The second shaving apparatus corresponds substantially to the first shaving apparatus, with the added provision of a compensating element 16 of a mass m4, which is secured to the rotor 7 by means of leaf springs 17 having a spring constant D3. Accordingly, compared to the first shaving apparatus, the block diagram of FIG. 5 shows in addition the mass m4 and the spring force acting between the masses m3 and m4 and characterized by a spring constant D3. Further differences to the first shaving apparatus lie in the dimensioning of the masses and the spring constants. Masses m1, m2, m3 and m4 exhibit decreasing values in the order of this enumeration. Regarding the spring constants the values increase in the order D1, D2 and D3. The values for the frequency f, for the braking force R and for the oscillation amplitudes x1, x2 and x3, on which the curve shapes of FIG. 6 are based, are identical to the corresponding values of the first shaving apparatus. Further values on which the curve shapes of FIG. 6 are based are the masses m1=70 g, m2=30 g, m3=12 g and m4=5 g, the spring constants D1=2 N/mm, D2=4 N/mm and D3=5.1 N/m, as well as the oscillation amplitude of the compensating element 16 x4=1.8 mm. Because of the high value of the oscillation amplitude x4 of the compensating element 16, on the ordinate of the graph of FIG. 6 a scale different from the one in the graph of FIG. 3 was selected. A different scale was also selected on the abscissa, to show more details. Some of the scales used in the further embodiments vary also.

The oscillatory behavior of the mass centers of the masses m1, m2 and m3 corresponds to that of the first shaving apparatus and will not be explained again in the following. The mass center of mass m4 whose curve shape is shown in a dot-and-dash line in FIG. 6 oscillates in phase with the mass center of mass m2 and in phase opposition to the mass center of mass m3. In other words, the compensating element 16 executes a strongly pronounced oscillation that is in phase with the shaving head 2 or the shaving foil 3 and in phase opposition to the undercutter 14. The mass distribution is preferably selected such that the mass centers of the masses m2, m3 and m4 move at least approximately on a common line.

Also in this example the resultant linear pulse and the resultant angular momentum are approximately equal to zero. In contrast to the first example this is accomplishable with a smaller mass in the area of the shaving head 2.

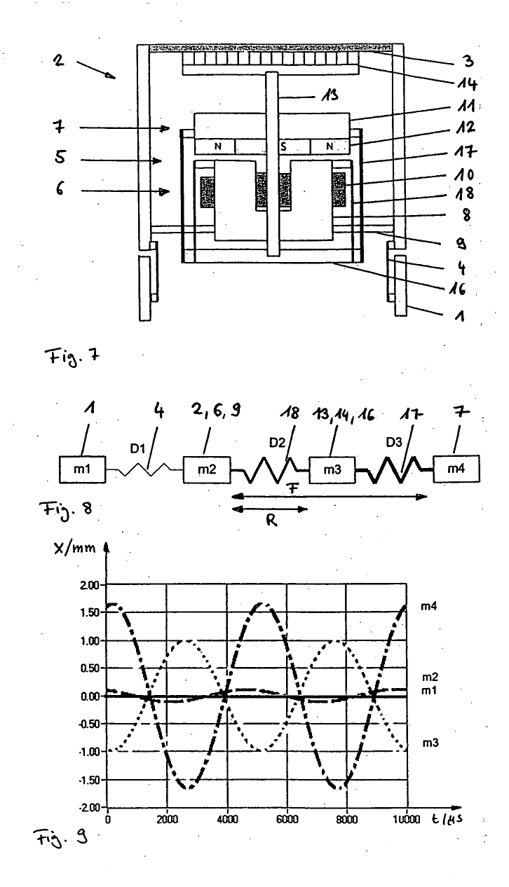

FIG. 7 shows a third shaving apparatus in a representation corresponding to FIG. 1. An associated block diagram of the oscillatory system is shown in FIG. 8. The oscillatory behavior of the oscillatory system is shown in FIG. 9.

Similar to the second shaving apparatus, provision is also made in this example for the compensating element 16. However, the geometrical arrangement of the rotor 7 and the compensating element 16 is reversed relative to the second shaving apparatus. Moreover, the undercutter 14 is not rigidly connected to the rotor 7 but to the compensating element 16. In lieu of the leaf springs 15 through which the rotor 7 is secured to the stator 6 in the first two examples, provision is made for leaf springs 18 securing the compensating element 16 to the stator 6. These modifications make it possible for the rotor 7 to be operated with an oscillation amplitude greater than the oscillation amplitude provided for the undercutter 14. In this way, a higher motor speed and hence a smaller electric motor 5 with a higher efficiency are accomplishable.

In the representation of FIG. 8, mass m1 continues to be formed by the housing 1, and mass m2 continues to be formed by the shaving head 2, the stator 6 and the brackets 9. Unlike the first two examples, mass m3 is formed by the undercutter 14, the rod 13 and the compensating element 16, and mass m4 by the rotor 7. Similar to the first two examples, the spring force of the leaf spring 4 characterized by the spring constant D1 acts between masses m1 and m2. Acting between masses m3 and m4 is the spring force of the leaf spring 17 characterized by the spring constant D2, as in the second shaving apparatus. Unlike the first two examples, the spring force characterized by the spring constant D2 and acting between masses m2 and m3 does not relate to the leaf spring 15 but to the leaf spring 18. In addition, in contrast to the first two examples, only the braking force R acts between masses m2 and m3. The magnetic force F acts between masses m2 and m4.

The masses, the spring constants and the oscillation amplitudes succeed each other in terms of magnitude in the same order as described in the second shaving apparatus. However, the curve shapes shown in FIG. 9 are in part based on parameters differing from those on which the curve shapes of FIG. 6 are based. The frequency has a value f=200 Hz, and the braking force a value R=1 N. The mass values are m1=70 g, m2=30 g, m3=20 g and m4=10 g. The spring constant values are D1=2 N/mm, D2=4 N/mm, and D3=10 N/mm. The oscillation amplitudes amount to x1=0.003 mm, x2=0.12 mm, x3=1.0 mm, and x4=1.7 mm.

Similar to the first two examples, the oscillatory motion of the mass center of mass m1 is so small that it is not visible in the representation of FIG. 9, meaning that the housing 1 hardly vibrates. The mass centers of masses m3 and m4 oscillate in phase opposition to each other, with the oscillatory motion of the mass center of mass m4 being more pronounced. The mass center of mass m2 executes an oscillatory motion that is approximately in phase opposition to the oscillatory motion of the mass center of mass m3. Also in the third embodiment the mass centers of masses m2, m3 and m4 move at least approximately on a common line. The resultant linear pulse and the resultant angular momentum are nearly equal to zero.

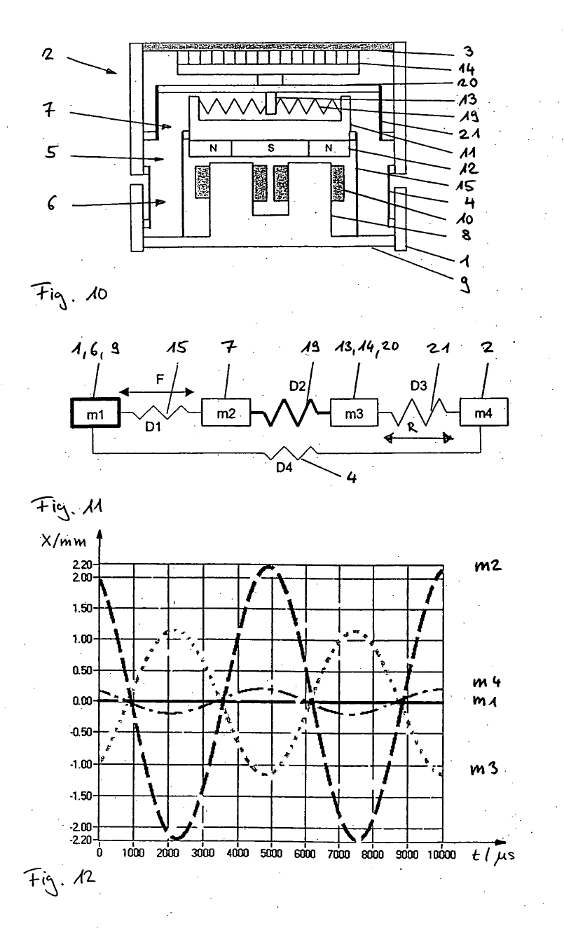

FIG. 10 shows a fourth shaving apparatus in a representation corresponding to FIG. 1. An associated block diagram of the oscillatory system is shown in FIG. 11. The oscillatory behavior of the oscillatory system is shown in FIG. 12.

In the fourth shaving apparatus the stator 6 is rigidly connected to the housing 1 by means of the brackets 9. The rotor 7 is secured to the brackets 9 by means of the leaf springs 15. The shaving head 2 is attached to the housing 1 through the leaf springs 4. The rod 13 arranged on the undercutter 14 is coupled to the rotor 7 through helical springs 19. Furthermore, the rod 13 is rigidly connected to a cross member 20. The cross member 20 is coupled to the shaving head 2 via leaf springs 21.

In the fourth shaving apparatus the rotor 7 drives both the undercutter 14 and the shaving head 2 inclusive of the shaving foil 3. For this purpose, the oscillatory motion of the rotor 7 is transmitted to the undercutter 14 through the helical springs 19 and the rod 13. The oscillatory motion of the undercutter 14 is transmitted to the shaving head 2 via the leaf springs 21. On each of these transmitting actions an oscillatory motion of opposite phase is produced. Hence the undercutter 14 oscillates in phase opposition to the rotor 7, and the shaving head 2 in phase opposition to the undercutter 14.

In the oscillatory system shown in FIG. 11, mass m1 is formed by the housing 1, the stator 6 and the brackets 9, mass m2 by the rotor 7, mass m3 by the undercutter 14, the rod 13 and the cross member 20, and mass m4 by the shaving head 2. Acting between masses m1 and m2 are the spring force of the leaf springs 15 characterized by the spring constant D1, and the magnetic force F. Acting between masses m2 and m3 is the spring force of the helical springs 19 characterized by the spring constant D2. The spring force of the leaf springs 21 characterized by the spring constant D3 and the braking force R act between masses m3 and m4. The spring force of the leaf springs 4 characterized by the spring constant D4 acts between masses m1 and m4.

In the fourth shaving apparatus the oscillatory system is preferably designed so that mass m1 has the highest value. Masses m2 and m4 are of like value and each smaller than mass m3. Of the spring constants D2 has the highest value. The spring constants D1 and D4 are of like value and each smaller than the spring constant D3. As a result, the oscillation amplitudes x1, x2, x3 and x4 exhibit increasing values in the order of this enumeration.

The curve shapes shown in FIG. 12 relate to a frequency f=200 Hz and a braking force R=1 N. The related masses are m1=100 g, m2=10 g, m3=20 g and m4=10 g. The spring constant values are D1=0.5 N/mm, D2=10 N/mm, D3=2 N/mm and D4=0.5 N/mm. The resultant oscillation amplitudes are x1=0.003 mm, x2=0.12 mm, x3=1.0 mm and x4=1.7 mm.

The oscillatory motion of the mass center of mass m1 is very small also in the fourth shaving apparatus. The oscillatory motions of the mass centers of masses m2 and m3 are in phase opposition to each other. Similarly, the oscillatory motions of the mass centers of masses m3 and m4 are in phase opposition to each other. The mass distribution is preferably selected at least approximately such that the mass centers of masses m2, m3 and m4 move on a common line. The resultant linear pulse and the resultant angular momentum are nearly equal to zero.

A number of embodiments of the invention have been described. Nevertheless, it will be understood that various modifications may be made without departing from the spirit and scope of the invention. Accordingly, other embodiments are within the scope of the following claims.

What is claimed is:

1. An electric shaving apparatus comprising
a hand-holdable housing; and
a shaving head coupled to the housing via at least one first elastic element and comprising:
a first shaving cutter;
a second shaving cutter; and
an electric motor that generates a first oscillatory motion of the shaving head and a second oscillatory motion of the second shaving cutter, said electric motor comprising:
a first drive component with at least one electric coil that generates a magnetic field; and
a second drive component that is movable relative to the first drive component and that cooperates with the first drive component to generate a motive force;
wherein the first drive component of the electric motor is rigidly connected to one of the shaving head and the housing.

2. The shaving apparatus of claim 1, wherein the electric motor is constructed as a linear motor.

3. The shaving apparatus of claim 1, wherein the second drive component is arranged in the shaving head.

4. The shaving apparatus of claim 1, wherein the second drive component includes at least one permanent magnet.

5. The shaving apparatus of claim 1, wherein the oscillatory motions of the shaving head and the second shaving cutter are in phase opposition to each other.

6. The shaving apparatus of claim 1, wherein the oscillatory motion of the shaving head has a smaller amplitude than the oscillatory motion of the second shaving cutter.

7. The shaving apparatus of claim 1, constructed such that, during the oscillatory motions of the shaving head and the second shaving cutter, the mass center of the shaving head, inclusive of all components rigidly connected to the shaving head, and the mass center of the second shaving cutter, inclusive of all components rigidly connected to the second shaving cutter, move on a common line.

8. The shaving apparatus of claim 1, wherein the first drive component and the second drive component are coupled via at least one second elastic element.

9. The shaving apparatus of claim 8, wherein the second elastic element has a greater spring constant than the first elastic element.

10. The shaving apparatus of claim 8, wherein the second elastic element is constructed as a leaf spring

11. The shaving apparatus of claim 1, wherein the second drive component is coupled to a compensating element via at least one third elastic element.

12. The shaving apparatus of claim 11, wherein the third elastic element has a greater spring constant than the second elastic element.

13. The shaving apparatus of claim 11, wherein the compensating element is rigidly connected to the second shaving cutter.

14. The shaving apparatus of claim 11, wherein the third elastic element is constructed as a leaf spring

15. The shaving apparatus of claim 1, wherein the second drive component is rigidly connected to the second shaving cutter.

16. The shaving apparatus of claim 1, wherein the second drive component is coupled to the second shaving cutter via at least one fourth elastic element.

17. The shaving apparatus of claim 16, wherein the fourth elastic element is constructed as a leaf spring

18. The shaving apparatus of claim 16, wherein the second shaving cutter is coupled to the shaving head through at least one fifth elastic element.

19. The shaving apparatus of claim 18, wherein the fifth elastic element is constructed as a leaf spring

20. The shaving apparatus of claim 1 wherein the first shaving cutter is constructed as a shaving foil.

21. The shaving apparatus of claim 1, wherein the second shaving cutter is constructed as an undercutter that cooperates with the first shaving cutter to cut hair.

22. The shaving apparatus of claim 1, wherein the first elastic element is constructed as a leaf spring.
